(19) United States
(12) Patent Application Publication
(10) Pub. No.: US 2026/0223950 A1
(43) Pub. Date: Aug. 6, 2026

(54) AEROSOL PROVISION DEVICE COMPRISING AN OPTICAL SENSOR

(71) Applicant: NICOVENTURES TRADING LIMITED, London (GB)

(72) Inventors: Zhihuang XIAO, London (GB); Scott BOHAM, London (GB); Nicholas ROSSER, London (GB)

(21) Appl. No.: 19/153,041

(22) PCT Filed: Jan. 31, 2024
(86) PCT No.: PCT/EP2024/052352

§ 371 Date: Aug. 1, 2025

(30) Foreign Application Priority Data
Feb. 1, 2023 (GB) 2301460.8

(51) Int. Cl. A24F 40/53; A24F 40/51

(52) U.S. Cl. CPC A24F 40/53; A24F 40/51

(57) ABSTRACT

An aerosol provision device configured to receive at least a portion of an article comprising aerosol generating material. The aerosol provision device comprises a light sensor, a light guide and a processor. The light guide is configured to receive a light signal from the article and transmit the light signal to the light sensor. The light sensor is configured to receive the light signal from the light guide. The processor is configured to determine article information from a property of the light signal.

### TECHNICAL FIELD

The present invention relates to an aerosol provision device, an aerosol provision system and an article.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with a first aspect, there is provided an aerosol provision device configured to receive at least a portion of an article comprising aerosol generating material, the aerosol provision device comprising a light sensor, a light guide and a processor, wherein the light guide is configured to receive a light signal from the article and transmit the light signal to the light sensor and wherein the light sensor is configured to receive the light signal from the light guide and the processor is configured to determine article information from a property of the light signal.

The light guide may extend between the article and the light sensor.

The light guide may change the direction of the light signal.

The light guide may transmit the light signal in a longitudinal direction of the device.

The light guide may transmit the light signal along a path between the article and the light sensor.

The path may be determined by the geometry of the light guide.

The light sensor may be arranged to be orientated perpendicular to the lightguide.

The light sensor may be arranged to be orientated on along the same axis as the lightguide.

The aerosol provision device may comprise a heating chamber, the light sensor being positioned at a distal end of the heating chamber away from a mouth end of the aerosol provision device.

The light sensor may be positioned away from a mouth end of the aerosol provision device.

Article information may comprise a presence of the article.

Article information may comprise a type of the article.

Article information may comprise an authentication status of the article.

The light sensor may be a colour sensor.

The light sensor may be an infrared sensor.

The light sensor may be an analogue camera.

The light sensor may be a digital camera.

The aerosol provision device may further comprise a light source to transmit a light signal to the article, wherein light signal is provided to the sensor by reflection of the light signal transmitted to the article from the light source.

The light guide may be further configured to direct the light signal from the light source to the article.

The aerosol provision device may further comprise a second light guide configured to direct the light signal from the light source to the article.

The light source may be positioned adjacent to a mouth end of the aerosol provision device.

The light source may be arranged to be positioned adjacent to the light sensor.

The light sensor may an image sensor.

The length of the light guide may be between 1 mm and 50 mm. The light guide may be approximately 1 mm to 12 mm in length.

The light guide may have a transparency of more than 32%. The light guide may have a transparency of 10% or more, 20% or more, 25% or more, 30% or more, 40% or more.

The lightguide may concentrate the light signal to provide an amplified signal to the light sensor.

The aerosol provision device may comprise a first and second portions that are separable at a boundary between the first and second portions.

The light signal may pass across the boundary between the first and second portions of the aerosol provision device before being received by the light sensor.

The lightguide may be arranged to cross the boundary between the first and second potions of the aerosol provision device.

The light guide may be ring shaped to receive reflected light from the article around an inner surface of the light guide.

The light guide may comprise an endoscope, the endoscope comprising optical fibres to receive the light signal from the article and transmit the light signal to the light sensor.

The property of the light signal may be dependent on an identifier arranged on the article.

The identifier may comprise a plurality of coloured portions.

The plurality of coloured portions may be arranged in a colour matrix comprising red, green, blue (RBG) portions.

The matrix may comprise three rows and three columns.

The aerosol provision device may further comprise an article sensor arranged to detect insertion of an article in the aerosol provision device.

According to a second aspect, there is provided an article comprising aerosol generating material, the article further comprising an indicator portion.

The indicator portion may reflect a first light signal to provide a reflected light signal that is indicative of article information.

According to a third aspect, there is provided an aerosol provision device configured to receive at least a portion of an article comprising aerosol generating material, the aerosol provision device comprising a camera and a processor, wherein the camera is configured to capture an image of a portion of the article and transmit the image to the processor and the processor is configured to determine article information from a property of the image.

The camera may be a digital camera.

The camera may be an analogue camera.

The camera may be positioned proximal to the mouth end of the aerosol provision device.

The camera may be positioned away from a mouth end of the aerosol provision device.

The aerosol provision device may further comprise a light source.

The light source may be in communication with the camera.

The light source may be configured to transmit light synchronously when the camera is activated.

The light source may be positioned adjacent to the camera.

The light source may positioned away from the camera.

The light source may be an led.

The article information may comprise a presence of the article.

The article information may comprise a type of the article.

The article information comprises an authentication status of the article.

The processor may be configured to authenticate the article in response to determining article information from the image.

The processor may be configured to select a heating session in response to identifying article information from the image.

The processor may be configured to communicate with a second device that is external to the aerosol provision device.

The second device may be configured to display article information to a user.

The aerosol provision device may further comprise an article sensor arranged to detect insertion of an article in the aerosol provision device.

The article sensor may be configured to transmit a signal to the camera.

The camera is activated in response to the camera receiving a signal indicating that an article has been inserted into the aerosol provision device.

The article sensor may be arranged at the mouth end of the aerosol provision device.

The article sensor may comprise a hall sensor.

The article sensor may comprise a mechanical sensor.

The article sensor may comprise a light sensor.

The article sensor may comprise a laser sensor The article sensor may comprise a camera.

According to a fourth aspect, there is provided a system comprising the aerosol provision device as described in the first or third aspect and an article, wherein the article comprises a portion comprising indicia.

The indicia may comprise a QR code.

The indicia may comprise a barcode

The indicia may comprise a colour matrix.

The indicia may comprise a plurality of coloured portions.

The plurality of coloured portions may be arranged in a colour matrix comprising red, green, blue (RBG) portions.

The matrix may comprise three rows and three columns.

According to a fifth aspect, there is provided method of operating an aerosol provision system comprising: receiving, at a sensor receiver, a signal comprising an article identifier; assigning, upon receipt of the signal, a flag to the article identifier, wherein the flag indicates that the article associated with the article identifier has been used.

The method may further comprise determining whether a flag has already been assigned to the article identifier.

The method may comprise preventing operation of a heating assembly in the aerosol provision if it is determined that a flag indicating that the article associated with the article identifier has been used has been assigned to the article identifier.

The sensor receiver may comprise a camera configured to receive the article identifier.

The article identifier may comprise a QR code.

The article identifier may comprise a barcode.

The signal may further comprise article information.

The article information may comprise a type of the article.

The article information may comprise an authentication status of the article.

The method may comprise applying a specific mode of operation for a session of use in response to identifying characteristics of the article information.

The method may further comprise connecting to an external processor and/or storage device via a Bluetooth connection, the flag being assigned at the external processor and/or storage device.

According to a sixth aspect, there is provided aerosol provision system comprising an aerosol provision device and an article comprising aerosol generating material, wherein the aerosol provision device is configured to receive at least a portion of the article, the aerosol provision device comprising a sensor configured to receive a signal comprising an article identifier, the aerosol provision system comprising a processor configured to determine article information from the signal, wherein the processor is further configured to assign a flag to the article identifier to indicate that the article associated with the identifier has been used.

The processor may be further configured to determine whether a flag has already been assigned to the article identifier.

The processor may be configured to prevent operation of the aerosol provision device if the article identifier already been assigned a flag indicating that article associated with the identifier has been used.

The sensor may comprise a camera arranged to receive the signal comprising the article identifier.

The sensor may be arranged away from a mouth end of the aerosol provision device.

The processor may be configured to assign additional article information to the article identifier.

The additional article information may comprise a digital signature.

The digital signature may comprise article information.

The digital signature may comprise a type of the article.

The article information may comprise an authentication status of the article.

The aerosol provision device may further comprise an article sensor arranged to detect insertion of an article in the aerosol provision device.

The article sensor may be arranged at the mouth end of the aerosol provision device.

The article sensor may comprise a hall sensor.

The article sensor may comprise a mechanical sensor.

The article sensor may comprise a light sensor.

The article sensor may comprise a laser sensor.

The article sensor may comprise a camera.

The features of any aspects or optional features specified above may be combined or included in the aerosol provision device, the article, the method or the system of any other aspect.

### BRIEF DESCRIPTION OF THE DRAWINGS

Embodiments will now be described, by way of example only, and with reference to the accompanying drawings in which:

FIG. 1 shows a side view of an aerosol provision system;

FIG. 2 shows a perspective view of an article;

FIG. 3 shows a cross-sectional side view of an aerosol provision system;

FIG. 4 shows a schematic drawing of an aerosol provision device comprising a light guide;

FIG. 5 shows a schematic drawing of an aerosol provision device comprising a camera; and

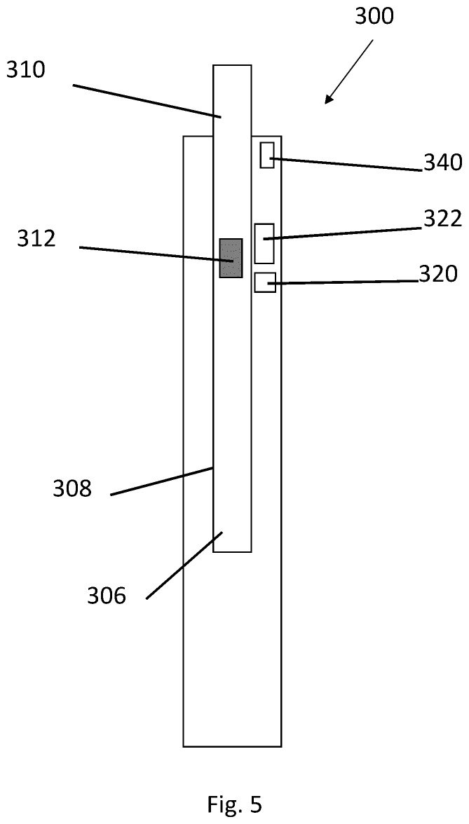

FIG. 6 shows a flow chart illustrating a method of operating an aerosol provision system.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

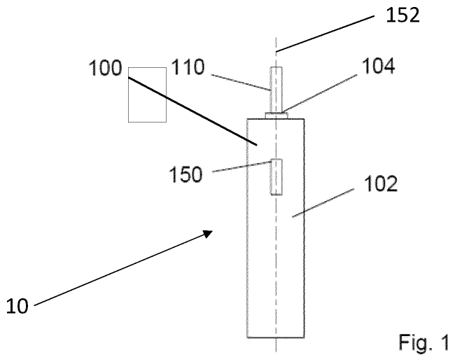

With reference to FIG. 1, an aerosol provision system 10 comprises an aerosol provision device 100 for generating aerosol from an aerosol generating material. The aerosol provision system 10 further comprises a replaceable article 110 comprising the aerosol generating material. In broad outline, the aerosol forming device 100 may be used to heat the article 110 to generate an aerosol or other inhalable medium, which is inhaled by a user of the device 100.

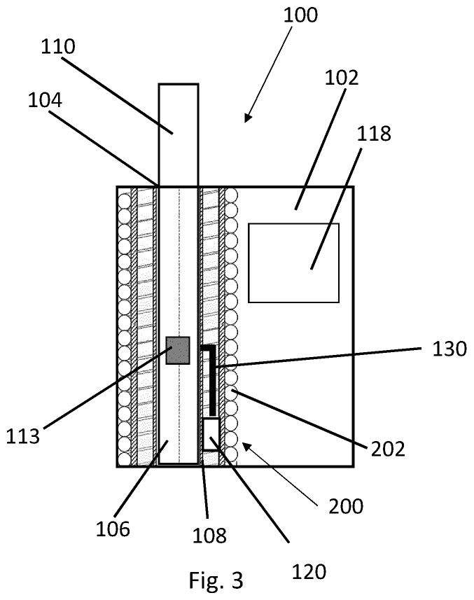

The aerosol forming device 100 comprises a body 102. A housing arrangement surrounds and houses various components of the body 102. An article aperture 104 is formed at one end of the body 102, through which the article 110 may be inserted for heating by an aerosol generator 200, which is described below with respect to FIG. 3. The article aperture 104 is formed at the mouth end of the device.

The device 100 may also include a user-operable control element 150, such as a button or switch, which operates the device 100 when pressed. For example, a user may turn on the device 100 by operating the switch 150.

The aerosol generator 200 defines a longitudinal axis 152, which aligns with an axis of the article 110.

In use, the article 110 may be fully or partially inserted into the aerosol generator 200 where it may be heated by one or more components of the aerosol generator 200.

The device 100 includes an apparatus for heating aerosol-generating material. The apparatus includes an aerosol generating assembly, a controller (control circuit), and a power source. The apparatus forms part of the body 102. The aerosol generating assembly is configured to heat the aerosol-generating material of an article 110 inserted through the article aperture 104, such that an aerosol is generated from the aerosol generating material. The power source supplies electrical power to the aerosol generating assembly, and the aerosol generating assembly converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source may be electrically coupled to the aerosol generating assembly to supply electrical power when required and under control of the controller to heat the aerosol generating material. The control circuit may be configured to activate and deactivate the aerosol generating assembly based on a user input. The user input may be via a button press or opening a door of the device (for example, a door covering a consumable receiving receptacle). The control circuit may be configured to activate and deactivate automatically, for example on insertion of an article.

The aerosol generating assembly may comprise various components to heat the aerosol generating material via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

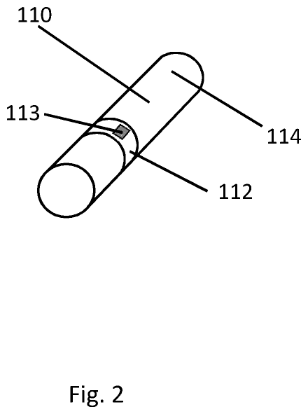

With reference to FIG. 2, the article 110 comprises an identifier 113. The identifier 113 may be arranged as part of an indicator portion 112. The identifier 113 and/or indicator portion 112 comprises indicia that is indicative of article information. The article information comprises a type of the article 110, for example, a flavour, a strength, authentication status, and/or a size of the article 110. The article 110 comprises the aerosol generating material (not shown in FIG. 2).

The indicator portion 112 and/or identifier 113 is on an outer surface 114 of the article 110. The outer surface 114 may be formed from paper, with the indicator portion 112 and/or identifier 113 printed on the paper. The indicator portion 112 is a band which surrounds the article 110. The indicator portion 112 encircles the article 110. As described in more detail below, the indicator portion 112 may be a coloured region to reflect light signals.

In embodiments, there may be no identifier 113 and only the indicator portion 112 is provided. In embodiments, the indicator portion may comprise a plurality of coloured bands that wrap around the outer surface 114 of the article 110.

In embodiments, the identifier 113 is arranged on an outer surface 114 of the article 110 on any part of the article 110. The identifier 113 may comprise a plurality of coloured portions. The coloured potions may be arranged in a colour matrix comprising red, green, blue (RGB) portions. The matrix may comprise three rows and three columns.

In embodiments, the indicia comprises a QR code or a barcode.

With reference to FIG. 3, a portion of the article 110 is received in a receptacle 106 of the aerosol provision device 100. The receptacle 106 is a cylindrical chamber, extending from the article aperture 104 into the body 102. The article 110 is inserted through the aperture 104 into the receptacle 106, such that the identifier 113 and/or the indicator portion 112 is positioned within the receptacle 106. The receptacle 160 is defined by a wall 108.

The aerosol provision device 100 comprises an aerosol generator 200. The aerosol generator 200 is a heating assembly. The aerosol generator 200 comprises an inductive element 202. The inductive element 202 is an inductive coil (also referred to as a “heating coil”) surrounding the receptacle 106. The aerosol generator 200 comprises a susceptor element 108, which, in the present embodiment, is the wall 108. As such, the receptacle 106 defines the heating chamber of the device 100.

The aerosol provision device 100 comprises a light sensor 120 and a light guide 130. A first end of the light guide 130 is positioned proximal to the identifier 113 of the article.

In embodiments, the light sensor 120 is positioned at the distal end of the heating chamber 106, away from the mouth end of the aerosol provision device 100. This is beneficial as the greatest condensation and heating that may affect operation of the light sensor 120 is found at the mouth end of the device 100.

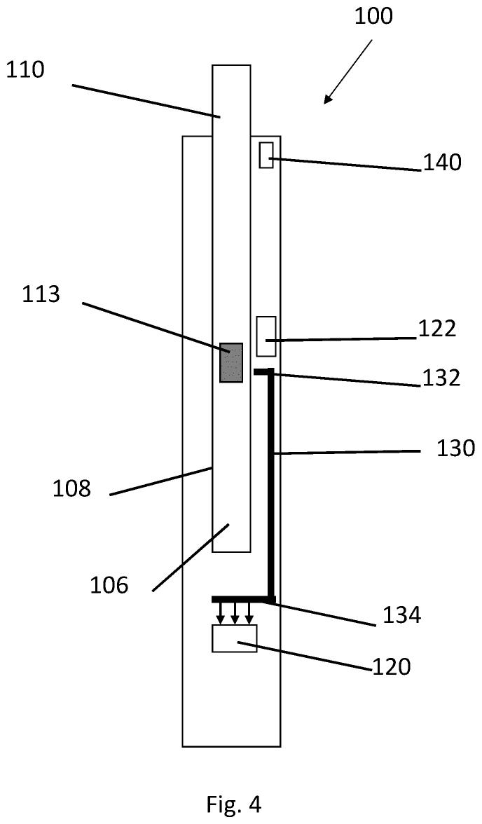

Referring to FIG. 4, a schematic drawing of the aerosol provision device 100 and article 110 is shown. The article 110 is inserted through the article aperture positioned within the heating chamber 106 that is defined by the wall 108. A light guide 130 has a first end 132 which is positioned adjacent to the wall 108. A second end of the light guide 130 is adjacent to the light sensor 120. The light guide 130 extends longitudinally along the device, from the article 110 to the light sensor 120. The light guide defines a path between the article 110 and the light sensor 120.

A light source 122 is positioned adjacent to the article identifier 113. The light source 120 may be, for example, an LED.

The light guide 130 has a length of at least 1 mm, at least 10 mm, at least 20 mm, at least 30 mm, or at least 40 mm.

In embodiments, the light guide may have a length of less than 10 mm, less than 12 mm, less than 20 mm, less than 30 mm, less than 40 or less than 50 mm.

In embodiments, the light guide may have a length of more than 50 mm.

The light guide has a transparency of 32% or more. In embodiments, the light guide may have a transparency of more than 37%, more than 53%, more than 66%, more than 82%, or more than 91%.

In embodiments, the light guide may have a transparency of less than 32%.

In embodiments, the light guide may have a transparency of 10% or more, 20% or more, 25% or more, 30% or more, 40% or more.

In use, the light source 122 is activated and transmits a light signal towards the article 110.

A reflected light signal is reflected back by the indicator 113 on the article 110. The reflected light signal is received at the first end 132 of the light guide 130. The reflected light signal is transmitted through the light guide 130 from its first end 132 to its second end 134.

The reflected light signal exits the light guide 130 at the second end 134. The second end 134 of the light guide is orientated parallel to the light sensor 120. The reflected light signal is received by the light sensor 120. The light guide 130 concentrates the reflect light signal to provide an amplified light signal to the light sensor.

In embodiments, the light sensor is orientated along the same axis as the light guide. The light sensor being orientated along the same axis may mean that the light sensor is configured to receive light travelling along the axis, parallel to the axis or with a component parallel to the axis. In embodiments, the light sensor is orientated perpendicular to the light guide. The light sensor being orientated perpendicular to the light guide may mean that the light sensor is configured to receive light that exits the light guide perpendicular to the path on which it has been transmitted.

The aerosol provision device 100 further comprises a processor (not shown in figures). The processor receives information from the light sensor 120 and is configured to determine article information from a property of the light signal.

The processor is further configured to execute specific actions on the aerosol generating device. For example, upon the processor determining that the article indicator 113 comprises a specific colour, the processor may control the aerosol provision device 100 to unlock. In another example, the processor may determine the presence of the article to commence a session of use. In other examples, the processor may determine the type of consumable from the article information and, in response, the processor may control the aerosol provision device 100 to operate in a predetermined mode corresponding to a predetermined heating profile.

An article sensor 140 may further be provided in the aerosol provision device 100 towards the opening. The article sensor 140 is located proximal the article aperture 104 at the mouth end of the device 100. The article sensor 140 is arranged to detect insertion of an article 110 in aerosol provision device.

The article sensor 140 is in communication with the processor. In response to the article sensor 140 communicating to the processor that an article 110 has been inserted into the receptacle 106, the processor is configured to control the light source 112 to activate.

The article sensor 140 may be a mechanical sensor, comprising a physical component such as a trigger or a button that is displaced when the article 110 is inserted into the receptacle 106. In response to the physical component being displaced, the sensor communicates to the processor than an article 110 has been inserted into the receptacle 106.

In embodiments, the article sensor may be an interruption sensor that comprises a light source and a light receiver. A light source may be arranged on the opposing side of the receptacle 106 to a light receiver. The light source is configured to emit a constant beam of light which is received by the light receiver. When an article 110 is inserted into the receptacle 106, the beam of light is blocked. The light received by the light receiver is interrupted and the sensor communicates to the processor than an article 110 has been inserted into the receptacle 106. The interruption sensor may alternatively be replaced by a laser sensor comprising a laser source and a laser receiver that operates in substantially the same way.

In embodiments, the article sensor may comprise a hall sensor that senses when an article comprising a metallic component has been inserted into the receptacle. In embodiments, the article sensor may comprise a camera-type sensor to detect insertion.

In embodiments, activation of the light source and light sensor is not reliant upon an article sensor. For example, the light source may be activated in response to a user input.

In embodiments, the path defined by the light guide 130 may differ. For example, the path may not have a bend at the second end 132. The light guide may wrap around the receptacle 106.

In embodiments, the second end of the light guide may be arranged at the mouth end of the device. The aerosol provision device may be provided as a two part device comprising first and second boundaries that are separable at a boundary between the first and second portions. The article is insertable into a heating chamber that extends across the boundary and into the first and second portions. The indicator portion is arranged to be received in the first portion. The light source is arranged in the first portion of the aerosol provision device. The light sensor is arranged in the second portion of the aerosol provision device. The reflected light signal passes across the boundary between the first and second portions of the aerosol provision device before being received by the light sensor. The light guide is configured to extend across the boundary between the first and second portions of the aerosol provision device to direct the light signal to the light sensor.

In embodiments, the light guide is ring shaped to receive reflected light from the article around an inner surface of the light guide. The light guide is then configured to transmit the reflected light to the alight sensor.

In embodiments, a further light guide may be provided. The further light guide may extend from the light source to the article identifier. In use, the further light guide transmits the light from the light source to the specific part of the article that comprises the article identifier.

In embodiments, the wall 108 comprises a translucent portion, adjacent to the first end of light guide 130, and the light guide and light sensor are positioned outside of the heating chamber.

The light sensor may be a different type of light sensor, for example an image sensor, an optic sensor or an infrared (IR) sensor.

In embodiments, the guide comprises an endoscope. The endoscope comprises optical fibres to receive the light signal from the article and transmit the light signal to the light sensor.

Referring to FIG. 4, and according to a further aspect, an aerosol provision device 300 may comprise a camera 310 in place of the light sensor. The aerosol provision device comprises a processor (not shown in figures). In embodiments, the camera 320 is a digital camera.

As in earlier embodiments, an article 310 is inserted into heating chamber 306. The heating chamber 306 is defined by wall 308. The article 310 comprises an identifier 312. The identifier 312 is an image. In embodiments, the identifier may be one or more of a simple image object, a QR code, a colour matrix (for example a RGB matrix), a blink code or a colour code.

The camera 320 is configured capture an image of at least the part of the aerosol generating article 310 comprising the identifier 312. The camera 320 is configured to transmit a digital signature of the captured image to the processor.

The camera 320 is positioned proximal to the mouth end of the aerosol provision device to minimise interference from condensation. In embodiments, the camera may be positioned away from the mouth end of the device.

The processor receives the digital signature from the camera 320 and is configured to determine article information from the image. The article information may comprise one or more of: a presence of the article; a type of the article; an authentication status of the article.

The processor may further be configured to authenticate the article in response to determining article information from the image and/or to select a heating session in response to identifying article information from the image.

The aerosol provision device 300 is also provided with an article sensor 340. The provided article sensor 340 works substantially the same as article sensor 140 described above.

A light source 322 that is configured to transmit light towards the article 310 is also positioned adjacent to the camera 320. The light source 322 may be an LED. The light source 322 is in communication with the camera 320. The light source 322 is configured to transmit light synchronously when the camera 320 is activated.

In use, the article sensor 340 detects insertion of the article 310 into the aerosol provision device 100. In response to the article sensor 340 communicating to the processor that an article 310 has been inserted into the receptacle 206, the processor is configured to control the light source 312 and camera 320 to activate synchronously.

In embodiments, activation of the light source and light sensor is not reliant upon an article sensor. For example, the light source may be activated in response to a user input.

In embodiments, the light source may be positioned away from the camera. A light guide may be provided between the light source and article to direct a light signal towards the identifier.

In embodiments, an analogue camera is provided. Where an analogue camera is provided, identifier 312 on article 310 may be one or more of a simple image object, a QR code, a colour matrix, a blink code or a colour code. The colour matrix may comprise a grid of nine coloured portions, for example a 3×3 matrix. The colour matrix may be a RGB matrix. Various arrangements of colours and grids may be used.

In embodiments, the processor may connect to a second device that is external to the aerosol provision device. The second device is configured to display article information to a user in a user interface. The second device may be configured to control, via user input to the user interface, the processor of the aerosol provision.

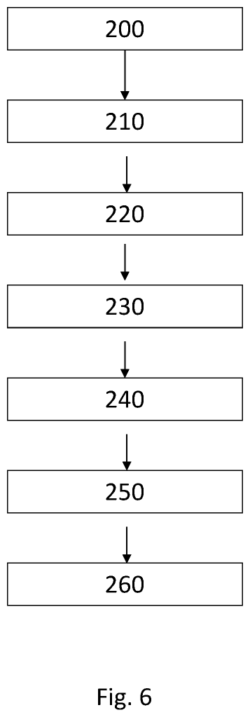

According to a further aspect, the aerosol provision device 100 may be operated as shown in the flow diagram of FIG. 6. The method may comprise any of the features or functional steps described above.

At the first step 200 the article 110 is inserted into the aerosol provision device 100 so that at least a portion of the article 110 that comprises the indicator portion 112 or identifier 113 is received in the receptacle 106 of the device 100.

At step 210, an article sensor 140 detects insertion and communicates that an article 110 has been inserted into the receptacle 106 to the processor.

In response, the processor controls the light source 112 to activate. At step 220, the light source transmits a light signal towards the article 110. A reflected light signal is reflected back by the indicator portion 112 or the identifier 113. The reflected light signal comprises article information.

At step 230 the light sensor 120 receives the reflected light signal and at step 240 the processor determines article information.

At step 250 the processor assigns a flag to the article identifier to indicate that the article associated with the identifier has been used.

The processer also determines, from the article information, if a flag has already been assigned to the article. At step 260, operation of the aerosol provision device is prevented if it is determined that flag indicating that the article associated with the article identifier has been used has previously been assigned to the article identifier.

In embodiments, a specific mode of operation for a session of use may be commenced in response to identifying characteristics of the article information. For example, the session of use may be operable in a boost mode in response to a characteristic of the article information. In embodiments, a personalised session of use may be commenced which is appropriate to the type of article as identified by the processor.

In embodiments, any of the aerosol provision device may connect to an external processor and/or storage device via a Bluetooth connection. The external processor and/or storage device may comprise a user interface such as an app. In embodiments, the flag is assigned at the external processor and/or storage device.

In the above described embodiments, the aerosol provision device comprises a heating arrangement that is an inductive heating arrangement. In embodiments, other types of heating arrangement are used, such as resistive heating. The configuration of the device is generally as described above and so a detailed description will be omitted. In such arrangements the aerosol generating assembly comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device configured to receive at least a portion of an article comprising aerosol generating material, the aerosol provision device comprising a light sensor, a light guide and a processor, wherein
the light guide is configured to receive a light signal from the article and transmit the light signal to the light sensor
wherein the light sensor is configured to receive the light signal from the light guide and the processor is configured to determine article information from a property of the light signal.

2. The aerosol provision device of claim 1, wherein the light guide extends between the article and the light sensor.

3. The aerosol provision device of claim 1, the light guide transmits the light signal along a path between the article and the light sensor.

4. The aerosol provision device of claim 3, wherein the path is determined by the geometry of the light guide.

5. The aerosol provision device of claim 1, wherein the aerosol provision device comprises a heating chamber, the light sensor being positioned at a distal end of the heating chamber away from a mouth end of the aerosol provision device.

6. The aerosol provision device of claim 1, wherein article information comprises one or more of: a presence of the article; a type of the article; and/or an authentication status of the article.

7. The aerosol provision device of claim 1, wherein the light sensor is on of: a colour sensor; an infrared sensor or an image sensor.

8. The aerosol provision device of claim 1, wherein the light sensor is an analogue camera.

9. The aerosol provision device of claim 1, wherein the light sensor is a digital camera.

10. The aerosol provision device of claim 1, further comprising a light source to transmit a light signal to the article, wherein light signal is provided to the sensor by reflection of the light signal transmitted to the article from the light source.

11. The aerosol provision device of claim 1, wherein the light guide is approximately between 1 mm and 50 mm in length, optionally wherein the light guide is between 1 mm and 12 mm in length.

12. The aerosol provision device of claim 1, wherein the light guide has a transparency at least 32%.

13. The aerosol provision device of claim 1, further comprising a second light guide configured to direct the light signal from the light source to the article.

14. The aerosol provision device of claim 1, wherein the aerosol provision device comprises a first and second portions that are separable at a boundary between the first and second portions.

15. The aerosol provision device of claim 1, wherein the light signal passes across the boundary between the first and second portions of the aerosol provision device before being received by the light sensor.

16. The aerosol provision device of claim 14, wherein the lightguide is arranged to cross the boundary between the first and second potions of the aerosol provision device.

17. The aerosol provision device of claim 1, wherein the light guide is ring shaped to receive reflected light from the article around an inner surface of the light guide.

18. The aerosol provision device of claim 1, wherein the light guide comprises an endoscope, the endoscope comprising optical fibres to receive the light signal from the article and transmit the light signal to the light sensor.

19. The aerosol provision device of claim 1, wherein the property of the light signal is dependent on an identifier arranged on the article.

20. The aerosol provision device of claim 19, wherein the identifier comprises one or more of: a plurality of coloured portions, wherein the plurality of coloured portions are arranged in a colour matrix comprising red, green, blue (RBG) portions and wherein the matrix comprises three rows and three columns.
